(19) United States
(12) Patent Application Publication
(10) Pub. No.: US 2007/0018559 A1
(43) Pub. Date: Jan. 25, 2007

(54) Printer light source device

(76) Inventor: Jeng-Ywan Jeng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/184,991

(22) Filed: Jul. 20, 2005

(51) Int. Cl. H01J 1/62; H01J 63/04

(52) U.S. Cl. 313/495; 313/497

(57) ABSTRACT

Several ways are proposed to protect a field emission illumination device of a printer light source device. A two-terminal field emission light source structure makes use of carbon nanotubes as an electron emitter to be used as an exposure light source component of an optical printer head. The printer light source device has a low manufacturing cost, and can be matched with a photosensitive drum structure. The printer light source device is characterized by a casing coating and a light guide device to realize a light source of low cost and high efficiency.

### BACKGROUND OF THE INVENTION

1. Field of the invention

The present invention relates to a two-terminal field emission light source structure making use of carbon nanotubes as an electron emitter, and used as an exposure light source component of an optical printer head. This light source structure has a low manufacturing cost, can be matched with a photosensitive drum structure, and is superior to the prior art printer light source structure.

2. Description of Related Art

There are many kinds of printers, including inkjet printers, laser printers, thermal transfer printers, and thermal dye sublimation printers. Commercially available optical printers include LED printers and laser printers, which differ only in exposure light sources used.

In a conventional optical printing mechanism, disclosed in U.S. Pat. No. 4,794,062, a photosensitive drum is matched with the paper feeding direction to rotate in a certain direction. The photosensitive drum is an electrostatic precipitator capable of adsorbing toner and transferring it to a fed paper. The mechanism makes use of a light source capable of producing varying light to expose the photosensitive drum. The exposed regions on the photosensitive drum have no electrostatic adsorption effect and thus do not adsorb toner. The light source variation mechanism is used to change the electrostatic adsorption mechanism on the photosensitive drum so as to form a carbon power layer on the photosensitive drum. The toner adsorbed by the photosensitive drum is then transferred to the fed paper. A series of toner exposure/developing mechanisms correspond to the photosensitive drum. As shown in FIG. 1, a toner removal mechanism 10a is used to remove the remaining toner after transfer. A powerful light mechanism 20a is used to remove electrostatic charges on a photosensitive drum 80a. An electrostatic generating device 30a is used to produce an electrostatic region on the surface of the photosensitive drum 80a. An exposure light source 40a is used to provide a light signal to expose the photosensitive drum 80a. The electrostatic adsorption effect of the exposed region on the photosensitive drum 80a will disappear. A toner supply device 50a is used to supply uniformly carbon power adsorbed by the surface of the photosensitive drum 80a. Because the exposed region on the photosensitive drum 80a has no electrostatic adsorption effect, there will be no toner thereon. The toner layer on the photosensitive drum 80a is then transferred to the surface of a fed paper 70a. Finally, a thermal fixing device 60a is used to fix the transferred toner on the surface of the fed paper.

In the prior art, the laser exposure light source mechanism uses a single laser light matched with a rotating multi-facet mirror for scanning and reflecting light to the photosensitive drum, while the LED exposure light source mechanism uses a linear light source composed of an array of LEDs. Because the pixel of the LED exposure light source structure is much larger than that of the laser exposure light source mechanism, it is necessary to match a circuit or a focusing lens capable of converging the light source signal for high-resolution printing.

Corresponding to the linear LED light source structure, a field emission light source is disclosed in Taiwan Pat. No. TW367432. A three-terminal field emission optical structure with a spindle-type cathode electron field emitter is used as a developing light source of printer head. This structure can be made with the thin film fabrication process, and can form a small-pixel, high-resolution linear light source to simplify the matched drive circuit. Moreover, a focusing lens is unnecessary. The requirement of the LED exposure light source mechanism can thus be met.

Because carbon nanotubes proposed by Iijima in 1991 have very good electronic characteristics, they have been used in several kinds of electronic components. The carbon nanotubes have an aspect ratio higher than 500 and a high rigidity with a Young's modulus above 1000 GPn. The tip or defect of the carbon nanotubes is exposed at the atomic level. Because of these characteristics, the carbon nanotube is thought of as an ideal electron field emitter material. For instance, it can be used as an electron field emitter on a cathode plate of a field emission display. Because the carbon nanotube has the above physical characteristics, it can be patterned on electronic components through several kinds of fabrication processes such as the screen printing and the thin-film fabrication process.

As shown in FIG. 2, a prior art simple field emission display 1b at least comprises an anode 3b and a cathode 4b. A unit structure 5b has a unit anode 51b and a unit cathode 52b with a rib 53b arranged in between. The rib 53b is used for separation of the vacuum region between the anode and the cathode and for support between the anode and cathode. As shown in FIG. 1, the anode 3b at least comprises an anode glass substrate 31b, an anode conducting layer 32b, and a phosphorus layer 33b. The cathode 4b at least comprises a cathode glass substrate 41b, a cathode conducting layer 42b, and an electron field emission layer 43b. The anode 3b and the cathode 4b are separated by the rib 53b. The rib 53b is also used to keep the vacuum class between the cathode structure and the anode structure. An external electric field is provided to drive the electron emission layer on the anode to generate electrons. The electrons irradiate and excite the phosphorus on the anode to produce light. In this two-terminal field emission display, in order to drive the cathode to generate electrons, the spacing between the cathode and the anode is about 50 to 200 μm. The required drive electric field intensity is usually 10 V/μm or less, or the turn-on voltage usually is 150 V or less. The light emission efficiency of phosphorus depends on the characteristic of the selected phosphorus material.

### SUMMARY OF THE INVENTION

An object of the present invention is to provide a two-terminal field emission light source structure making use of carbon nanotubes as an electron emitter to be used as an exposure light source component of an optical printer head. This light source structure has a low manufacturing cost, and can be matched with a photosensitive drum structure.

To achieve the above object, the present invention includes a casing coating and a light guide device to provide an anti-electrostatic or anti-EM wave function in addition to the illumination function, and to guide a small-pixel high-resolution light source to a photosensitive drum. The present invention can be matched with the conventional field emission display manufacturing process and peripherals that can be easily manufactured.

The printer light source device comprises a field emission illumination device arranged at a side of a roller of a printer to form an exposure light source. The field emission illumination device further comprises an anode structure having a phosphorus layer, a cathode structure having a carbon nanotube layer, a rib supporting structure located between the cathode structure and the anode structure, a casing coating for protecting the field emission illumination device from interference, and a gas absorption chamber for keeping the vacuum class between the anode structure and the cathode structure.

### BRIEF DESCRIPTION OF THE DRAWINGS

The various objects and advantages of the present invention will be more readily understood from the following detailed description when read in conjunction with the appended drawing, in which:

FIG. 1 is a diagram of a prior art light source device installed in a printer;

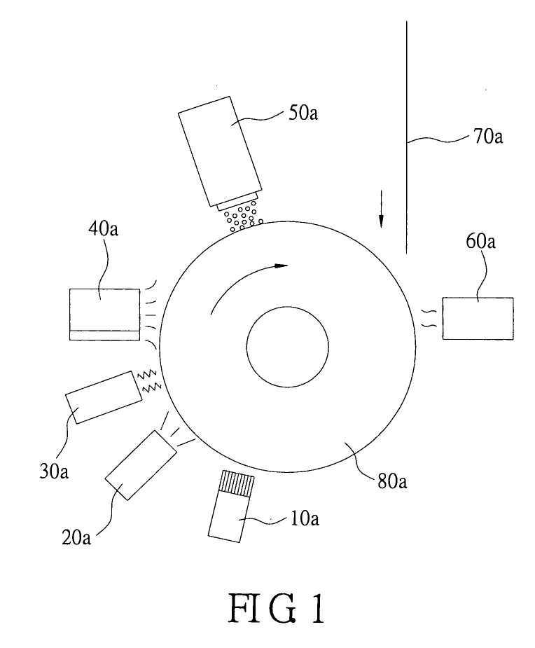

FIG. 2 is a diagram of a prior art field emission illumination device;

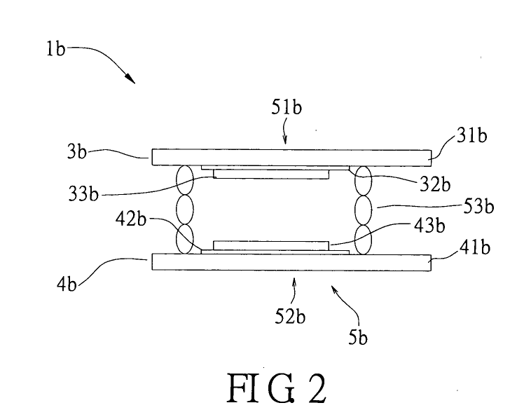

FIG. 3 is a diagram of a printer light source device according to an embodiment of the present invention; and

FIG. 4 is a diagram of a printer light source device according to another embodiment of the present invention.

### DETAILED DESCRIPTION OF THE PREFERRED EMBODIMENTS

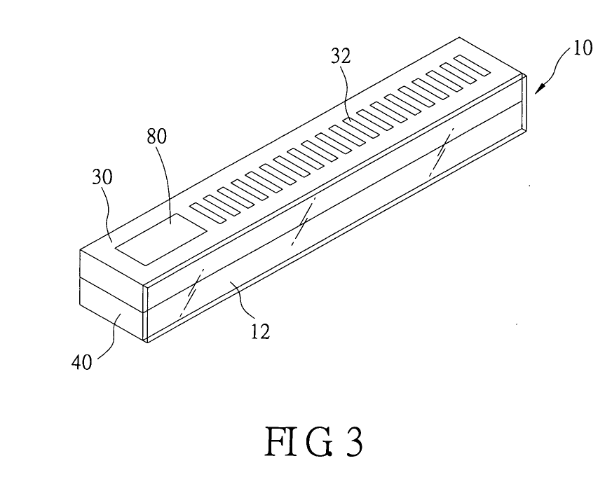

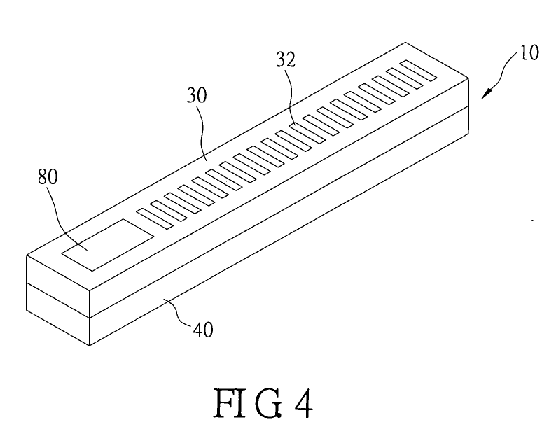

As shown in FIGS. 3 and 4, the present invention provides a printer light source device having a carbon nanotubes cathode, in which a field emission illumination device 10 comprises an anode structure 30, a cathode structure 40, and an alternative circuit. The anode structure 30 has a phosphorus layer, which emits light when bombarded by electrons emitted by the cathode structure 40. The bottom of the field emission illumination device 10 can have a reflecting film to reflect reverse fluorescent light of the cathode back to an illumination block 32. A rib of the cathode and the anode can also have a reflecting film to reflect reverse fluorescent light of the cathode back to an illumination block 32. The cathode structure 40 has a carbon nanotube layer capable of emitting electron beams when biased by a voltage, and a gas absorption chamber 80 for keeping the vacuum class between the anode structure and the cathode structure. The alternative circuit has a voltage applying terminal generally connected to the anode structure or a gate. The cathode structure 40 is at a potential of 0 V. The alternative circuit can bear a current with a predetermined AC frequency and a predetermined AC voltage applied between the voltage applying terminal and the cathode. The anode structure 30 has a casing coating 12 for protection. The illumination block 32 is generally composed of a plurality of display areas, and can have a drive circuit connected to an external drive power source. The present invention can be a two-terminal (the cathode emitting electron beams to the anode) or three-terminal (the cathode emitting electron beams to the gate and the anode) structure. If the present invention is a three-terminal structure, the gate is usually mechanically connected with the cathode structure and located between the anode structure and the cathode structure to facilitate fabrication. Because the control logic is much the same as ordinary semiconductor diodes or triodes, it is easy to develop the control IC by modifying existent ICs.

As shown in FIG. 4, the field emission illumination device 10 can further comprise a gate located between the cathode structure 40 and the anode structure 30 to enhance brightness. The field emission illumination device 10 can also comprise an alternative circuit. The alternative circuit has a voltage applying terminal. The alternative circuit can bear a current with a predetermined AC frequency and a predetermined AC voltage applied between the voltage applying terminal and the cathode. The predetermined AC voltage is within ±150V to ±3 KV. The predetermined AC frequency is within 12 kHz to 14 kHz. The voltage applying terminal can be connected to the anode or a gate. The phosphorus layer or the carbon nanotube layer is coated by means of screen printing or spraying. The field emission illumination device 10 can further comprise a shock-resistant pad structure disposed at the installed interface to prevent the mechanism from shaking due to affecting characteristics of the printer light source device. The casing coating has an electrostatic conducting layer or an anti-EM wave layer, which is disposed on an outer surface of the anode structure or the cathode structure and connected to a grounding circuit to decrease the influence of electrostatic effects or EM waves. The casing coating has a heat-conducting layer located on an outer surface of the anode structure or the cathode structure to enhance the heat-radiating capability. The field emission illumination device 10 can further comprise a leakage light reflecting layer located inside, beside, or at a bottom of the field emission illumination device to enhance the illumination capability thereof. The casing coating has an etch-resistant coating disposed on an outer surface of the anode structure or the cathode structure to enhance the etch-resistant capability. The field emission illumination device 10 can further comprise a light guide device with an outer light guide cover, which has a light guide structure to guide light to a photosensitive drum by using a transparent structure.

The present invention is characterized by (1) self-illumination and a brightness as high as 1000 nits or above; (2) low power consumption depending on the number of the illumination blocks and generally lower than 1 W; (3) a high-resolution light source capable of performing high-end printing; and (4) high environmental adaptation for industrial applications.

To sum up, the light source structure of the present invention has a simple fabrication process, a low cost, and can match the photosensitive drum and the printer structure. The space occupied thereby is small. Moreover, the present invention can be used as the light source structure for high-end printers to meet the high-resolution pixel requirement.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A printer light source device, comprising:
a field emission illumination device arranged at a side of a roller of a printer to form a exposure light source, said field emission illumination device further comprising:
an anode structure having a phosphorus layer;
a cathode structure having a carbon nanotube layer;
a rib supporting structure located between said cathode structure and said anode structure;
a casing coating for protecting said field emission illumination device from interference; and
a gas absorption chamber for maintaining a vacuum between said anode structure and said cathode structure.

2. The printer light source device as claimed in claim 1, further comprising a gate located between said cathode structure and said anode structure to enhance brightness.

3. The printer light source device as claimed in claim 1, further comprising an alternative circuit with a voltage applying terminal, said alternative circuit being able to bear a current with a predetermined AC frequency and a predetermined AC voltage applied between said voltage applying terminal and said cathode, said predetermined AC voltage being within a range of about ±150V to ±3 KV, said predetermined AC frequency being within a range of about 12 kHz to 14 kHz, and said voltage applying terminal being connected to said anode or a gate.

4. The printer light source device as claimed in claim 1, wherein said phosphorus layer or said carbon nanotube layer is coated by means of screen printing or spraying.

5. The printer light source device as claimed in claim 1, further comprising a shock-resistant pad structure disposed at an installed interface to prevent shaking due to affecting characteristics of said printer light source device.

6. The printer light source device as claimed in claim 1, wherein said casing coating has an electrostatic conducting layer or an anti-EM wave layer, wherein said electrostatic conducting layer or anti-EM wave layer is disposed on an outer surface of said anode structure or said cathode structure, and connected to a grounding circuit to decrease influence of electrostatic effects or EM waves.

7. The printer light source device as claimed in claim 1, wherein said casing coating has a heat-conducting layer located on an outer surface of said anode structure or said cathode structure to enhance a heat-radiating capability thereof.

8. The printer light source device as claimed in claim 1, further comprising a leakage light reflecting layer located inside, beside or at a bottom of said field emission illumination device to enhance an illumination capability thereof.

9. The printer light source device as claimed in claim 1, wherein said casing coating has an etch-resistant coating disposed on an outer surface of said anode structure or said cathode structure to enhance an etch-resistance capability thereof.

10. The printer light source device as claimed in claim 1, further comprising a light guide device with an outer light guide cover, wherein said outer light guide cover has a light guide structure to guide light to a photosensitive drum by using a transparent structure.
